(19) United States
(12) Patent Application Publication
(10) Pub. No.: US 2007/0233508 A1
(43) Pub. Date: Oct. 4, 2007

(54) Corporate Control Management Software

(76) Inventor: David Gillespie, Cannon Hill (AU)

Correspondence Address: EDWIN D. SCHINDLER, FIVE HIRSCH AVENUE, P.O. BOX 966, CORAM, NY, 11727-0966, US

(21) Appl. No.: 11/568,679

(22) PCT Filed: May 5, 2005
(86) PCT No.: PCT/AU05/00643

§ 371 Date: Nov. 3, 2006

(30) Foreign Application Priority Data
May 5, 2004 (AU) 2004902395

(51) Int. Cl. G06Q 90/00

(52) U.S. Cl. 705/1

(57) ABSTRACT

An integrated application software suite for corporate governance includes modules, which have a command center, a meeting manager, a subsidiary manager, a software controls manager, a certification manager, a disclosure manager and a repository manager.

### AREA OF THE INVENTION

This invention relates to the area of software for use by corporate management in implementing an internal control framework and in particular to software for providing reporting on the effectiveness of internal control and procedures over financial reporting and the like.

### BACKGROUND OF THE INVENTION

A Recent spate of accounting irregularities and allegations of wrongful document destruction are driving stronger enforcement of existing regulations, as well as the creation of new laws with stronger penalties. One of the most significant of the new laws is the Sarbanes-Oxley Act of 2002 in the USA.

This law prescribes a sweeping system of additional Federal oversight of companies covering corporate governance and financial practices of publicly traded companies. The most onerous provisions for the corporation flowing from Sarbanes-Oxley are compliance with sections 302 and 404. These provisions now require the CEO and CFO to personally attest to the accuracy of financial reports and the effectiveness of the underlying system of risk management.

The regulatory insistence on extended board accountability, reporting, certification and disclosure, is widely expected to substantially—and in some cases exponentially—increase workloads for corporate officers and board members.

### OUTLINE OF THE INVENTION

It is an object of the software of this invention to directly target and effectively and comprehensively mitigate the challenges now facing Corporate Secretaries, CEOs, CFOs, the board of directors, the Audit Committee and Disclosure Committee while at the same time offering a solution that is more extensive than mere compliance.

The invention is an integrated application software suite for corporate governance having modules which include a command center, a meeting manager, a subsidiary manager, a software controls manager, a certification manager, a disclosure manager and a repository manager.

It is preferred that the a command center hosts all other modules and provides a unified and integrated security and administration framework as well as single intuitive point of access for all users,

It is also preferred that the meeting manager provides secure around the clock access from anywhere in the world to critical business information, meeting management services and accelerated reporting tools.

It is further preferred that the subsidiary manager provide the company secretary's office with a system which captures essential information on all subsidiary companies including details of officers and document lodgments.

It is also preferred that the certification manager provide a structured auditable compliance questionnaire capability to optimize the capture of compliance information.

It is further preferred that the repository manager integrates documents, records, emails and such processes.

It is further preferred that the software controls manager be an internal control module which provides both a framework and tool with which to document relevant processes, process maps, risks related to each process and the controls to manage the risks.

It is also preferred that the software controls manager includes the following features:
Facilitation of the documentation of internal controls by:
   Allowing companies to document templates at the corporate level for detailed implementation at the business unit level
   Collaboration on the development of risks and controls
   Leveraging leaders' content, particularly the control governance framework
Providing a comprehensive repository of Accounts, related processes, risks and control activities to manage risks.
An objective basis of evaluating the internal control framework. This is done through the control governance framework.
Real-time assessment of the risks and controls in each business unit A certification process which satisfies Section 302 requirements in regard to internal controls over financial reporting
Management authorization of the system and internal and external audit the functionality to certify controls and processes.
A self assessment functionality with the ability to notify each control activity owner in advance that the control activity needs to be done and the self assessment completed.
Effective visibility at all levels of the system

In order that the invention may be more readily understood we will describe by way of non limiting example a specific embodiment of the invention.

### BRIEF DESCRIPTION OF AN EMBODIMENT OF THE INVENTION

For ease of description the invention will be referred to herein in terms of its application to a specific software module referred to as Leaders Online.

A feature of the invention is the tight integration with the Board Management and Questionnaire modules of Leaders Online in that no other application suite integrates all of these aspects in corporate governance. In particular the way that evidence stored in the system from any point (Board, Questionnaires and Controls) goes into a secure and searchable managed repository and the access permissions to the evidence are appropriately and accurately maintained are unique.

A further significant feature of the invention is its integration with a document and records management system and its Controls Manager which is described here as follows.

Introduction

1.1. Purpose

Leaders Online Controls manager represents an extension of the company's Sarbanes Oxley suite of products. The Sarbanes Oxley suite now includes:
Command center for Directors and Executives
Certification manager,
Controls manager,
Disclosure manager
Enterprise Document and Records management
Corporate search

Section 404 of the Sarbanes Oxley act requires every public company listed in the USA, including foreign corporations, to implement an internal control framework. In addition section 404 requires that management report on the effectiveness of the internal control and procedures over financial reporting as of year end, based on management's evaluation. External auditors are required to attest to managements report and evaluation of internal control.

Section 302 requires that the CEO and CFO certify each quarterly and annual report. In doing so, the CEO and CFO must assess the effectiveness of the internal controls over financial reporting.

Controls manager provides a comprehensive solution to any public company irrespective of size. The solution is mandated by law and US based public companies need to be compliant by their financial year end after 14 Jun. 2004. Foreign corporations need to be compliant for their financial year ends after 14 Apr. 2005.

This represents a substantial opportunity as there are approximately 15,000 publicly listed corporations that are affected by this legislation.

1.2. Product Fit

Controls manager is part of Leaders Online—Sarbanes Oxley suite. Controls manager addresses the most demanding aspects of Sarbanes Oxley—Section 404 compliance.

80-20 Software's core technology is document management. Document management utilizes data base software to store the objects.

80-20 Document Manager is a data base application. Leaders Online utilizes many of the features of 80-20 Document Manager and once again stores all unstructured data in the data base. This also makes Leaders Online a data base application.

80-20 Software uses the major data base products which include Microsoft SQL and IBM DB2. Oracle integration is in the planning stages.

1.3. Market Need

The Sarbanes Oxley law requires every publicly listed company in the USA to have an internal control system. This system acts as the repository for internal controls and also provides the ongoing functionality to allow management to state in their annual reports that such a system exists and is operating effectively. In addition the CEO and CFO are required to certify at each reporting period that no material weaknesses exist in their internal control system as it relates to financial reporting.

1.4. Product Definition

Controls manager is designed to achieve the following objectives:
Facilitate the documentation of internal controls by:
   Allowing companies to document templates at the corporate level for detailed implementation at the business unit level;
   Collaboration on the development of risks and controls;
   Leveraging leaders' content, particularly the control governance framework;
Comprehensive repository of Accounts, related processes, risks and control activities to manage risks.
Objective basis of evaluating the internal control framework. This is done through the control governance framework.
Real-time assessment of the risks and controls in each business unit.
Certification process which satisfies Section 302 requirements in regard to internal controls over financial reporting.
Management authorization of the system and internal and external audit the functionality to certify controls and processes.
Self assessment functionality with the ability to notify each control activity owner in advance that the control activity needs to be done and the self assessment completed.
Effective visibility at all levels of the system.

1.5 Definitions, Acronyms etc

The following definitions and acronyms are encountered throughout this document.

Sox—Sarbanes Oxley law

Leaders—80-20 Leaders Online

Controls manager—COSO compliant internal controls system developed by 80-20 Software

Certification manager—Compliance questionnaire and certification software system developed by 80-20 Software

Disclosure manager—Facilitates the disclosure process in publicly listed companies. Solution developed by 80-20 Software

COSO—Committee of sponsoring organizations. The sponsoring organizations include Institute of Internal Auditors, American Institute of Certified Public Accountants, American Accounting Association, Institute of Management Accountants and the Financial Executives Institute.

SEC—Securities and Exchange Commission

MD&A—Management discussion and analysis

2.1 Users of the Invention

Within a given company or business the first point of contact will be the Group Controller or the Project Manager. Each project is likely to have an IT person allocated to the project to advise on any technology issues. Any software acquired by the project team will as a matter of course be subject to the software buying policies within the company and will require the approval of IT.

Alternatively one can approach IT first as they are likely to be aware of the Sox requirements but not the detail.

2.2. Use of the Invention

The invention provides as follows:

Comprehensive and fully integrated Sox suite including Leaders Board and Executive meeting management (Command centre), Controls manager, Certification manager and Disclosure manager. This is all underpinned with document and records management capability.

Comprehensive repository of controls, fully documented, with detailed profiles of components, points of focus, issues, accounts, processes, process maps, risks, and control activities,

Real time system

Comprehensive summary and certification tools and process. This includes linkage between compliance questionnaires and controls and meeting management functionality for the relevant executive and board committees, Certification manager underpins the 302 financial certifications and any other compliance processes requiring regular certification,

Full system visibility. The governance and controls framework use tree navigation functionality. At any point in the controls system the system provides a diagram mapping accounts to processes, processes to risks and risks to controls. In addition the powerful reporting functionality can provide the user with a full view of all controls and their relationship to other elements of the system, Powerful Risk heat map functionality which allows the user to view whatever risks with the required report. Heat map functionality allows for the consolidation of all risks and the corporate user can view severe and high risks for the entire corporation. Heat maps of risks relating to non complying controls can also be viewed,

Powerful reporting tools providing a wide range of reports to suite all parties, Excellent executive dashboard overview of the system and it's current status, Ability to attach evidence in the self assessment process,

Full set of policies, procedures and standard forms.

Implementation guidelines for the technology and controls,

Standard set of documentation for the governance framework,

Controls self assessment with notification functionality to remind users to do the self assessment

Management certification of every element of the system Internal and external audit certification

Detailed audit logs,

Tailored solution based on the COSO internal control framework,

Full document management and data base support of the system

Scaleable across large corporations with multiple business units and users,

Quick and easy implementation

Browser access

Comprehensive security settings allowing only authorized users access to the relevant parts of the system,

All modules of the Sox suite are data base applications.

3.1. Summary of the Controls Module of the Invention

Controls manager is an integrated module of 80-20 Software's Sarbanes Oxley suite. The Sarbanes Oxley suite includes:
Command center for Directors and Executives
Certification manager,
Controls manager,
Disclosure manager
Enterprise Document and Records management
Corporate search

Summary: Controls manager is based on the COSO framework and allows for detailed profiling of all relevant risks and related control activities which manage these risks. The control activities are allocated to owners and provide a self assessment framework which immediately notifies management of non compliant controls and the actions required to achieve compliance. The system automatically sends notification to control activity owners prompting the owners to do their regular self assessment. The system allows both the Internal and External auditors a framework to certify controls.

Controls manager also provides users with a control governance framework, in accordance with the COSO framework. The control governance framework is implemented at a corporate level only and this framework provides the objective basis by which the CEO and CFO can certify the internal controls of the company.

The system is web based and allows access from anywhere on the internet or within the business' intranet. The reporting functionality is very flexible and comprehensive.

3.2. Product Design

The diagrams below reflect the high level design of Controls manager.

[image]

The governance framework diagram shows how the control governance will operate. Internal control consists of five interrelated components. These are derived from the way management runs a business and are integrated with management processes.

The control environment provides an atmosphere in which people conduct their activities and carry out their control responsibilities. It serves as the foundation for other components. Within this environment management assess risks to the achievement of specified objectives. Control activities are implemented to help, ensure that management directives to address risks are carried out. Meanwhile relevant information is captured and communicated throughout the organization and externally to interested parties. The entire process is monitored and modified as conditions warrant.

The product is designed so that information flows up the “tree” thus allowing conclusions to be drawn at the component level which is then summarized and certified.

Points of Focus simply represent the next level of detail for each component (sub headings) and the issues represent the detailed compliance questions which require a response. At every level an owner is appointed and the owner is responsible for self assessment. Notification is provided to each owner to prompt them to complete the issues, points of focus and components allocated to each user.

The system allows for management authorization, signifying that it is complete, and finally it also allows for both internal and external audit to certify each of the issues, the components and the summary.

Controls Framework

The diagram below shows the more detailed part of the internal control system.

[image]

The controls framework is designed to be implemented at the business unit or entity level.

The project team at the corporate level is able to prepare templates which can then be implemented in more detail at the business unit level, thereby controlling the quality and uniformity of the product, particularly where the business units conduct similar businesses and have similar processes.

The business rules for the relationship between Business units, accounts, processes, risks and control activities are as follows:
A corporation will have at least one business unit;
Each business unit may have many accounts but at least one;
An account may have many sub accounts but may have none;
A sub account may have many sub sub-accounts but may have none;
An account, sub account or sub sub-account may have many processes but must have at least one;
A process may have many sub processes but may have none;
A sub process may have many sub sub-processes but may have none;
A process, sub process or sub sub-process may have many risks but must have at least one;
A risk has at least one control activity; and
Every control activity will be related to at least one risk.

Profiles: At each level certain key information is captured. (referred to as the “profile”) The account, process, risk and control activity profiles capture selected information detailed in the Controls framework below.

Accounts: For each business unit or entity major accounts are required to be identified. Accounts can include notes, MD&A and any other elements considered appropriate for inclusion. However, instead of starting with the major accounts, the business unit can choose to start at the process level. The advantage of starting with major accounts is the business unit can quickly ascertain whether the material aspects of the balance sheet and Profit & Loss account have controls.

Processes: Processes are identified and related to each account. For any one account there may be more than one process and processes may well be repeated for different accounts. For example the sales process relates to both revenue and accounts receivable.

Process Mapping: Having identified all relevant business and management processes, the business unit may select to map each of these processes. This allows the process owner to more easily identify the major business risks. Process mapping however, is not necessary and the business unit can choose to move from process to identifying the risks inherent in each process.

Navigation diagram: At the process level the navigation diagram shows a navigation diagram that maps accounts to processes and processes to risks. At the risk and control activity level the navigation diagram maps processes to risks and risks to control activities.

Risks: Risks need to be identified in each process. In most cases there will be more than one risk for a particular business or management process. In most organizations that have effective risk management systems, an inventory of risks will be available. To ensure the risks are comprehensive, the business unit should ensure that all risks identified in the risk management system are dealt with by the internal control system.

Control Activity: Control activities refer to the controls that need to be effected to ensure that the related risks do not materialize. For example a business will have credit risks when taking on new customers. The control which manages credit risk is credit checks on new customers and existing customers. There is likely to be at least one control activity for each risk. In certain circumstances a single control activity may deal with more than one risk. Each control is allocated to an owner and the owner needs to do periodic self assessments. In the event that the control is not operating effectively and the user certifies that the control is not functional, the owner is prompted to note what action will be taken and the due date of the action. The risk owner is automatically notified, together with the process owner and Business unit owner of the non compliant control and details of the action. The process owner or business unit owner can at any stage view the details of all non compliant controls under their responsibility.

Shortcuts: Provides the user with a view of the relevant items they are authorized to view. For example the process owner will be able to view his/her process profile, process map, risks and control activities and can quickly determine the status of controls. Security is designed such that any user can look down the “tree” but cannot look up or across at other processes, risks and controls. This is detailed in 3.6 below.

Reporting: Powerful reporting functionality and specific tailoring to suite the individual users' requirements. Detailed information is captured in the various profiles and reports can be generated that match information the user wishes to view. Standard reports for each user may be established.

3.3 Governance Framework versus Controls Framework.

The screenshot below shows how access is provided to the two parts of the internal control system: v,1/2

The Controls Framework is implemented at a business unit level and represents the detailed risks and controls identified in all major business and management processes. The objective is to document the detail, allocate ownership of processes, risks, and control activities to employees, provide a self assessment framework for control activity and process owners and finally, detail the actions required to ensure all controls are compliant. The result is a comprehensive report of all non compliant controls, actions, together with management comment in relation to materiality and significance. Internal and External auditor review functionality is also provided.

The final summary of processes, risks and controls for each business unit is summarized in the summary section of the governance framework. The final business unit certifications are contained within the certification section of the governance framework.

In contrast the Governance Framework deals with policies and procedures for each of the five components. The Governance framework is preferably only implemented at the corporate level as policies and procedures will normally relate to the entire corporation. Similar to the control framework the governance framework provides for self assessment with regard implementation of policies and procedures. The governance framework consists of 5 components (as directed by COSO) and within each component under various subheadings (referred to as Points of Focus) a number of issues are identified that require assessment. For example under the Control environment component there will be a control which requires the control owner to assess and show evidence that “The codes of conduct have been communicated to all senior financial staff and these employees have acknowledged these codes of conduct”.

The controls framework feeds into the internal controls component.

The CEO and CFO are only able to certify the effectiveness of their internal controls once all business nits have certified that their controls frameworks are effective and the corporation has certified that all components are effective with no material weaknesses.

3.4. Governance Framework

An assessment framework which informs the user whether the internal control framework is operating effectively, highlighting issues management need to address. Any material weaknesses in the internal control framework will be represented in the various component summaries.

The screenshot below show the various elements of the governance framework.

[image]

The governance framework is composed of 5 components. These are:

1. Control environment: Sets the t one of the organization thereby influencing the control consciousness of its people. It is the foundation for all other components of internal control, providing discipline and structure. Control environment factors include integrity, ethical values and competence of an organizations people, managements' philosophy and operating style, the way management assigns authority and responsibility, organizes and develops its people; and the attention/direction provided by the board of directors.
Points of focus include:
   Integrity and ethical values,
   Commitment to competence,
   Board of directors and audit committee,
   Management's philosophy and operating style,
   Organizational structure,
   Assignment of responsibility,
   Human resource policies and practices.

2. Risk Assessment: Every business faces a variety of risks from external and internal sources that must be assessed. A precondition to risk assessment is establishment of objectives, linked at different levels and internally consistent. Risk assessment is the identification and analysis of relevant risks to the achievement of the objectives, forming a basis for determining how the risks should be managed. Because economic, industry, regulatory and operating conditions will continue to change, mechanisms are needed to identify and deal with the special risks associated with change.
Points of focus include:
   Entity wide objectives,
   Activity level objectives,
   Risks,
   Managing change.

3. Control activities: Control activities are the policies and procedures that help ensure management directives are carried out. They ensure that necessary actions are taken to address risks to achievement of the entities objectives. Control activities occur throughout the organization, at all levels and in all functions. They include a range of activities as diverse as approvals, authorizations, verifications, reconciliations, reviews of operating performance, security of assets, and segregation of duties.
Points of focus include:
   Types of control activities,
   Controls over information systems,
   Integration with risks,
   Integration with processes,
Business unit control and risk summaries.

4. Information and communication: Pertinent information must be identified, captured and communicated in a form and timeframe that enables people to carry out their responsibilities. Information systems produce reports, containing operational financial and compliance-related information, that make it possible to run and control the business. They deal not only with internally generated data, but also information about external events, activities and conditions necessary to informed business making decision and external reporting.
Effective communication must also occur in a broader sense, flowing down, across and up the organization. All personnel must receive a clear message from top management that control responsibilities must be taken seriously. They must understand their own role in the internal control system, as well as how individual activities relate to work of others. They must have a means of communicating significant information upstream. There also needs to be effective communication with external parties such as customers, suppliers, regulators and shareholders.
   Points of Focus include:
      Information
      Management information and reporting,
      Timely, relevant information to the right people,
      Information systems revision to meet strategic objectives,
      Management support for development of information systems.
      Communication
      With employees,
      Reporting improprieties,
      Employees to management,
      Across the organization,
      External parties,
      Management follow through.

5. Monitoring: Internal control systems need to be monitored—a process that assesses the quality of the systems performance over time and at any given point in time. This is accomplished through various levels of monitoring. This includes business unit or entity level assessment of the entire controls framework, relevance and accuracy of processes, risks and controls, quality of documentation for every level of profile, status of compliance, reliability of 302 certification, effectiveness of self assessment and the status of action plans, particularly those dealing with material risks.
At the corporate level, assessment of the governance framework, relevance and accuracy of the various components, points of focus and issues, quality of documentation, effectiveness of self assessment, status of action plans, the quality and accuracy of the summary and finally the reliability, effectiveness and accuracy of the entire internal control framework.
Component profile: Includes the following information:
   Owner;
   Component name;
   Description of what the component entails;
   Summary and conclusion of component;
   Authorization and date—signifies that the component profile has been authorized by management. Only authorized users are allowed to authorize the component profile;
   Certified and date—signifies the certification status by the owner;
   Actions—summarizes the actions required by management to achieve full compliance. Outstanding actions may be immaterial and on this basis the component may still be certified;
   Internal audit review, date and conclusions;
   External audit review, date and conclusions;
   Notification capability—allows the owner to notify themselves as to when they should do their certification; and
   Red, yellow and green certification flags for owner, internal audit and external audit certification.
The screenshot below shows part detail of the component profile [image]
Points of Focus: Points of focus represent the various subheadings for each component as noted above. For each point of focus a number of issues are identified which require regular certification and self assessment. The results of the self assessment and certification are summarized in the profile of each point of focus.
Point of focus profile: includes the following information:
   Component to which it relates;
   Point of focus name;
   Owner;
   Description;
   Summary and conclusion;
   Authorization and date—signifies that the point of focus profile has been authorized by management. Only authorized users are allowed to authorize the point of focus profile, normally the component owner;
   Certified and date—signifies the certification status by the owner;
   Actions—summarizes the actions required by management to achieve full compliance. Outstanding actions may be immaterial and on this basis the point of focus may still be certified;
   Internal audit review, date and conclusions;
   External audit review, date and conclusions;
   Notification capability—allows the owner to notify themselves as to when they should do their certification; and
   Red, yellow and green certification flags for owner, internal audit and external audit certification;

The screenshot below reflects some details of the point of focus profile.

[image]

Issues: Issues represent the detailed policies and procedures that management deems necessary for each component to be compliant. Issues are the required practices and each owner must certify through a self assessment framework that the issues have been adequately dealt with. For example an issue could be “Does the company have codes of conduct for senior executives and financial staff”

Issue profile: includes the following information:
Component;
Point of focus;
Parent issue if it is a sub issue;
Issue owner;
Issue name—abbreviated from the description;
Issue description—Sets out in detail the policy or procedure which needs to be carried out;
Authorization and date—signifies that the issue profile has been authorized by management. Only authorized users are allowed to authorize the issue profile, normally the point of focus owner;
Self assessment—Yes/No answer;
Self assessment—Ability to attach proof in the form of documents;
Action details in the event the issue is not compliant;
Notification capability—allows the owner to notify themselves as to when they should do their self assessment;
Internal audit review, date and conclusions;
External audit review, date and conclusions; and
Red, yellow and green certification flags for owner, internal audit and external audit certification.

The screenshot below reflects details of the issues profile. (Note: This is incomplete)

[image]

Summary: represents the overall evaluation of the internal control system. In effect this is extracted from the five component summaries. Under the following headings:
Internal control components -summarizes the objectives of the various components;
Conclusions—summarizes the conclusions reached on each component;
Actions required—summarizes the details of actions and notes the significance or materiality of the actions;
Internal audit conclusions;
External audit conclusions;
Additional considerations; and
Overall conclusion for all components;
Business unit summaries are also accessed in this section.

Certification: contains the CEO and CFO certifications from each business unit including the corporate owner responsible for the governance framework. Invariably the corporate certification will include sign off from the CEO CFO and Group Controller or equivalent. The combination of the Summary and certifications will form the essence of reports to be presented to the audit committee. The report capability is flexible to generate those reports the audit committee may wish to view.

In determining S302 certification the corporation can use compliance questionnaires. The compliance questionnaires address a number of questions about financial systems policies etc and the respondent can link the relevant part of the compliance questionnaire to the internal control system.

The content of the certification forms will be determined by each entity based on independent legal advice.

3.5. Controls Framework

The controls framework is implemented at a business unit level and represents the detailed risks and controls identified in all major business and management processes. The objective is to document this detail, allocate ownership of processes, risks, and control activities to employees, provide a self assessment framework for control activity and process owners and detail the actions required to ensure all controls are compliant. The result is a comprehensive report of all non compliant controls, actions, and management comment about their materiality and significance. Process owners are regularly required to certify their processes, with an overall summary, conclusion and details of any actions underway. Full functionality for internal and external auditors review is also provided.
Business Unit: designed to be implemented at the business unit or entity level. The project team at the corporate level are able to prepare templates which can then be implemented in more detail at the business unit level, thereby controlling the quality and uniformity of the product particularly where the business units conduct similar businesses and have similar processes.
Accounts: For each business unit or entity major accounts are required to be identified. Accounts can include notes, MD&A and any other elements considered appropriate for inclusion. However, rather than the major accounts the business unit can choose to start at the process level. The advantage of starting with major accounts is the business unit can quickly ascertain whether the material aspects of the balance sheet and Profit & Loss account have been identified.
Account profile: At each level in the system certain key information is captured. Referred to as the “profile”, it captures the following information:
   Account owner;
   Account name;
   Account description,;
   Account value;
   Account authorization and date—signifies that the account profile has been authorized by management. Only authorized users area allowed to authorize the account profile, normally the business unit owner;
   Save changes—allows the owner to make changes to the account profile,
   Create sub account—allows the user to create sub accounts if necessary; and
   Create Process—allows the user to identify the processes related to this account.
The screenshot below reflects details of account profile. (Not complete) [image]
Processes: Processes are identified and related to each account. For any one account there may be more than one process and processes may well be repeated for different accounts. For example the sales process relates both to the revenue account and accounts receivable account.
Process mapping: allows the user to map processes making it easier to identify risks and relevant controls to manage the risks. It also provides a useful record of exactly how the process operates and requires regular review to ensure the mapped processes are still accurate.
Process profile: captures the following information:
   Process name;
   Process owner;
   Process description;
   Business cycle;
   Process authorization—signifies that the process profile has been authorized by management. Only authorized users are allowed to authorize the process profile, normally the business unit owner;
   Process certification by process owner;
   Summary & conclusion;
   Regularity of certification;
   Notification capability—allows process owners the ability to notify themselves in advance of due dates for certification;
   Actions, due dates and action responsibility (captured from the related controls);
   Internal audit certification, date and comment;
   External audit certification, date and comment;
   Save changes—provides the owner with the ability to make changes;
   Create sub processes—allows the authorized user to create sub processes;
   Create risks—allows the authorized user to create risks related to the process;
   Create accounts and/or sub accounts—allows the authorized user to build the related account structure if the business unit starts the controls implementation with processes and sub processes;
   Create process map—provides the authorized user with the ability to create the process map;
   Show controls diagram—allows the user to view how accounts and sub accounts are mapped to processes and sub processes;
   Show process map—allows the user to view the process map of the process described in the profile; and
   Red, yellow and green certification flags for owner, internal audit and external audit certification.

The screenshot below reflects details of the process profile (Not complete) [image]
Risks: Risks need to be identified in each process. In most cases there will be more than one risk for a particular business or management process. In most organizations that have effective risk management systems, an inventory of risks will be available. To ensure the risks are comprehensive the business unit should ensure that all risks identified in the risk management system are dealt with by the internal control system.
Risk Profile: captures the following information:
   Risk owner;
   Risk name;
   Account or sub account to which it relates;
   Process;
   Sub process;
   Risk description;
   Risk type—selected from a fixed list of risk types or automatically determined by ratings—for example a 9:9 rating is a severe risk;
   Financial impact rated on a scale of 1 to 10;
   Probability of occurrence rated on a scale of 1 to 10;
   Management authorization and date authorized;
   Internal audit certification, date and comment;
   External audit certification, date and comment;
   Show controls diagram—allows the user to view how processes and sub processes are mapped to risks;
   Save changes—provides the owner with the ability to make changes;
   Create control activity—allows authorized user to create the necessary control activities;
The screenshot below reflects the profile of risks. [image]
Control Activity: Control activities refer to the controls that need to be implemented to ensure that related risks do not arise. For example a business will have credit risks when taking on new customers. The control which manages credit risk is credit checks on new customers and existing customers.
There is likely to be at least one control activity for each risk. Each control is allocated to an owner and the owner needs to do periodic self assessments. In the event that the control is not operating effectively and the user certifies that the control is not functional, the system prompts the owner to note what action will be taken and the due date of the action. The risk owner, process owner and business unit owner are all notified automatically that the control is not compliant and details of the action. The process owner or business unit owner can at any stage view the details of all non compliant controls under their responsibility.
Control activity profile: captures the following information:
   Control activity owner;
   Control activity name—abbreviated;
   Control activity detailed description;
   Control objective—selected from a fixed list of objectives;
   Management authorization, date and name;
   Self assessment—the control owner signs off that the control is operating.
   Control self assessment regularity—informs the user how often the Assessment needs to be done—monthly, quarterly half yearly or annually. It also provides the specific date by when the control needs to be assessed;
   Evidence—The system allows the user to attach whatever documentary evidence is necessary to prove the control is functioning effectively;
   Control activity action and due date—in the event that the control is not being done the owner is prompted to complete an action;
   Automatic notification.—the control activity owner may choose to remind him/herself that the control self assessment is due in a certain number of days or on a specified date;
   Show navigation diagram—This allows the user to view how processes and sub processes are mapped to risks and control activities;
   Internal audit review, certification, comment and date of review;
   External audit review, certification and date of review; and
   Red, yellow and green certification flags for owner, internal audit and external audit certification.
The screenshot below reflects the profile of control activities

[image]

3.6 Shortcuts:

The shortcuts provide the user with a view of the relevant parts of the system that they are authorized to view. For example the process owner will be able to view his/her process profile, process map, risks and control activities, actions and can quickly determine the status of controls. Security is designed such that any user can look down the “tree” but cannot look up or across at other processes, risks and controls. The shortcuts include the following:
Executive Dashboard—can be tailored for the business unit or corporate depending on their specific requirements. Only authorized users are allowed access to view the executive dashboard. At the business unit level this will be determined by the business unit owner,
Listing—directs the user to the main system from which the user selects the relevant business unit,
Selection—provides an alternative route to the relevant part of the system. (a drill down capability).
Actions represent the actions under your control. For example if you are the business unit owner you will view all actions arising from non compliant controls. If you are the process owner you will view all actions related to controls that relate to the process you own. If you are a control activity owner you will view only the actions for which you are responsible;
My controls—provides the user access to control activity profiles they own and also controls that flow from risks and processes owned by the user.
In other words the process owner can view all related controls from this point;
My risks—provides the user with access to risk profiles they own or are authorized to view;
My issues—provides users direct access to issues they are authorized to view or edit.
My Reports—Provides access to all reports. Refer below for details of reporting functionality.

The screenshot below reflects details of the shortcuts

[image]

3.7 Reporting.

Functionality is very powerful and can be tailored to suite the individual users' requirements. The system captures detailed information in the various profiles. Reports can be generated that match whatever information the user may wish to view. The system also allows each user to set up standard reports.

Clicking on the “reports” icon in the shortcut sidebar will display a format by which the user can select the type of report to be generated. Each report type will prompt the user to select a number of fields, and the contents of these fields will be displayed in the report. In addition the user has the option in each case of selecting to produce a heat map of all related risks.

Once the report selection is made, the user has the option of either printing the report or saving the report as a record, in which case it is archived as a permanent document. Since the system is a real time system which changes regularly as users update controls etc. it is appropriate that management save a copy of the entire system at the point of certification. Saved documents are archived and the business unit owner can choose whatever documents they wish to save and archive, which then becomes a useful record for management, auditors and audit committee. It can also act as an audit trail in the event of any SEC investigation or audit.

The screenshot below highlights the various reporting options the user has. Standard reports as the name implies can be tailored for the organization. The balance of the report options are as follows:
Accounts;
Processes;
Risks;
Controls;
Control Governance;
Certification;
Internal audit;
External audit; and
Audit logs.

The screenshot below reflects the reporting functionality.

[image]

For each report type, the user can select a range of relevant fields to be reflected. Default settings are established at implementation and each user can alter these by changing the fields relating to any one of the report types.

The first five reports: Accounts, Processes, Risks, Controls and Governance framework all have a similar tabular framework. For each, one selects a business unit or all business units, and then the details of the fields the user wishes to view.

Account: Selection fields include account, sub account and sub sub account. These can be grouped by business unit, account, process, rick type and control objective. The following information can be viewed for each account:
Account
   Owner
   Value
Process
   Process owner
   Business cycle
   Sub process
   Sub sub process
Risks
   Risk owner
   Risk type
Control activities
   Owner
   Compliance (yes/no)
   Control objective
Assessments
   Frequency
   Most recent (date)
   Conclusions
   Actions
Certifications
   Management (Yes/No, Date, comment)
   Internal audit (Yes/No, Date, comment)
   External audit (Yes/No, Date, Comment)

Processes: Selection fields include processes, sub processes and sub sub processes. These can be grouped by business unit, account, process, risk type and control objective. The following information can be viewed for each process:
Process
   Process owner
   Business cycle
Account
   Owner
   Value
   Sub accounts
   Sub sub accounts
Risks
   Risk owner
   Risk type
Control activities
   Owner
   Compliance (yes/no)
   Control objective
Assessments
   Frequency
   Most recent (date)
   Conclusions
   Actions
Certifications
   Management (Yes/No, Date, comment)
   Internal audit (Yes/No, Date, comment)
   External audit (Yes/No, Date, Comment)

The screenshot below reflects the details of the above:

[image]

Risks: Selection fields include risk rating (starting with all risks, severe through to trivial). These can be grouped by business unit, account, process, risk type and control objective. The following information can be viewed for each risk:
Risks
   Risk owner
   Risk type
   Description
   Financial impact rating
   Likelihood rating
Account
   Value
Process
   Process owner
   Business cycle
   Sub process
   Sub sub process
Control activities
   Owner
   Compliance (yes/no)
   Control objective
Assessments
   Frequency
   Most recent (date)
   Conclusions
   Actions
Certifications
   Management (Yes/No, Date, comment)
   Internal audit (Yes/No, Date, comment)
   External audit (Yes/No, Date, Comment)

Control activities: Selection fields include all controls, compliant controls or non compliant controls. These can be grouped by business unit, account, process, risk type and control objective. The following information can be viewed for each control activity:
Control activities
   Owner
   Description
   Compliance (yes/no)
   Control objective
Assessments
   Frequency
   Most recent (date)
   Conclusions
   Actions and due date
Risks
   Risk owner
   Risk type
   Description
   Financial impact rating
   Likelihood rating
Account
   Value
Process
   Process owner
   Business cycle
   Sub process
   Sub sub process
Certifications
   Management (Yes/No, Date, comment)
   Internal audit (Yes/No, Date, comment)
   External audit (Yes/No, Date, Comment)

Control Governance: Initial selection fields are the various components. These can then be grouped by business unit or component. The following information can then be viewed for each component:
Component
   Owner
   Description
   Summary & conclusion
   Authorization (date)
   Certification (date)
   Actions
   Internal audit review, date & comment
   External audit review, date & comment
Points of focus
   Owner
   Description
   Summary & conclusion
   Authorization (date)
   Certification (date)
   Actions
   Internal audit review, date & comment
   External audit review, date & comment
Issues
   Owner
   Description
   Self assessment—Yes/No and date
   Actions
   Conclusions
   Internal audit review, date & comment
   External audit review, date & comment
Certifications
   Management—date
   Internal audit—date
   Internal audit—comment
   External audit—date
   External audit—comment

Certification: The user selects the business unit and then determines what certifications to access. The following are available:
CEO certifications
CFO certifications
Corporate certifications
Governance framework Summary and certification
Process certifications
Internal audit certifications
External audit certifications

Summaries: The user selects the business unit and then selects summaries by date. In most cases these will coincide with certification dates—Quarterly.

Internal audit: The user selects Business unit, Processes (None, All, reviewed, Not reviewed) or Controls (None, All, reviewed, Not reviewed) or Components (None, All, reviewed, Not reviewed). These can be grouped by business unit only. The following information can be viewed against each element selected:
Audit
   Internal audit certified (yes/no)
   Internal audit comment
   External audit certified (yes/no)
   External audit comment
Processes
   Owner
   Description
   Owner certified
   Summary and conclusions
   Actions and due dates
Control activities
   Owner
   Description
   Compliance—Yes/No
   Action & due date
   Last assessment date
   Assessment frequency
Component
   Owner
   Description
   Summary & conclusion
   Certification—Date
   Actions
Risks
   Description
   Rating (Severe to trivial)

External audit: The user selects Business unit, Processes (None, All, reviewed, Not reviewed) or Controls (None, All, reviewed, Not reviewed) or Components (None, All, reviewed, Not reviewed). These can be grouped by business unit only. The following information can be viewed against each element selected:
Audit
   External audit certified (yes/no)
   External audit comment
   Internal audit certified (yes/no)
   Internal audit comment
Processes
   Owner
   Description
   Owner certified
   Summary and conclusions
   Actions and due dates
Control activities
   Owner
   Description
   Compliance—Yes/No
   Action & due date
   Last assessment date
   Assessment frequency
Component
   Owner
   Description
   Summary & conclusion
   Certification—Date
   Actions
Risks
   Description
   Rating (Severe to trivial)

Audit Logs: the user will be able to extract information regarding changes to the system, timing thereof and who effected the changes.

3.8 Business Rules

3.8.1 Governance Framework

The business rules for the relationship between components. points of focus and issues are as follows:
There are five components plus a summary and certification,
Each component will have more than one point of focus,
Each point of focus will have at least one issue,
Each issue may have one or more sub issues,
The functionality required for an issue and a sub issue is the same.

3.8.2 Controls Framework

The business rules for the relationship between Business units, accounts, processes, risks and control activities are as follows:
A corporation will have at least one business unit,
Each business unit may have many accounts but at least one,
An account may have many sub accounts but may have none,
A sub account may have many sub sub accounts but may have none,
An account, sub account or sub sub account may have many processes but must have at least one,
A process may have many sub processes but may have none,
A sub process may have many sub sub processes but may have none,
A process, sub process or sub sub process may have many risks but must have at least one,
A risk has at least one control activity.
Control activities may have one or more risks.

3.8.3 Authorization and Security.

Security is designed as follows:
At the corporate level an individual will be appointed owner and they have the ability to view the entire system,
The corporate owner may nominate others that have the authority to view the entire system,
The governance framework which is designed to operate only at the corporate level can only be edited by profile owners. So for example the component profile owners can edit their profiles, but no-one else is entitled to edit the profiles,
Component profile owners can view points of focus and issues for the profiles they own,
Point of focus owners can edit the point of focus but can only view the issues that derive from the point of focus,
Issue owner can edit the issues they own and cannot view any other part of the system,
Business unit owners and nominated others are entitled to view the entire business unit system,
The control framework has similar rules for editing and viewing. The profile owner can edit the profiles of accounts, processes, risks and control activities. No-one else is entitled to edit the profiles. The system can allow for a business unit owner to edit any part of the system if this is approved by the corporate owner,
The account owner can view & edit the accounts for which they are responsible only,
The process owner can view and edit the processes they own, but can only view related risks, and control activities. Process owners can't view details of any processes they don't own,
Risk owners can view and edit the risks they own and can view all related control activities. Risk owners cannot view risks they don't own, unless they are the process owner and are viewing related risks,
Control activity owners can only edit and view controls that they own.

3.9 Processes

The Internal control system involves the following processes:
Management authorization
Control self assessment
Certification
Internal audit
External audit
Change management

Management Authorization

Authorization of each part of the system indicates that the relevant authorized managers have approved the design and content of the system. The system policies should provide clear guidelines as to the frequency when the governance framework and controls framework need to be authorized. Whenever business processes change or a merger or acquisition is completed, the internal control system needs to be reviewed and authorized by the relevant management.

The governance framework consists of components, points of focus, issues, summaries and certification and the control framework consists of accounts, processes, process maps, risks and control activities. At every level of the system the design and content of the system need to be consistent with the operations of the business.

At the time of implementation these details are documented and the system allows for each and every part of the system to be authorized by the relevant management. In the case of the corporate entity and the governance framework, the corporate owner and designated others will authorize the various parts of the system.

At the business unit level the business unit owner and designated others will authorize the system.

The system also allows for mass authorization of the governance framework and the controls framework. Group authorization can occur at the process level in which case everything related to the process is authorized.

Evidence of authorization will be reflected in the profile of every element of the system described above, and will note name and date the relevant part of the system that was authorized. The reporting functionality allows the corporate/business unit owner to view details of when the various elements of the system were last authorized.

Control Self Assessment

Self assessment functionality is provided at the lowest levels of the governance and controls framework. Within the both the governance framework and controls framework each issue and control activity needs to be assessed at predefined frequency intervals. In some cases this may only be once a year and in other cases it may be more regular. The system allows the owner to set the system to send regular notifications at preset dates to notify the owner that the issue requires self assessment. The issue owner then enters the system and by clicking on “my issues” is automatically directed to the relevant issues requiring self assessment or alternatively can click on a URL from the notification and is immediately taken to the relevant part of the system.

Where self assessment on issues and controls are overdue, notifications are automatically sent to the process owner or business unit/corporate owner.

If the issue or control is not compliant the system prompts the owner to complete details of action and due date.

The reporting functionality allows any user to immediately identify issues and controls that are not compliant, actions to be taken and due dates. Management is then required to follow up on actions to ensure these are effectively implemented. The system keeps a record of actions and color codes actions red if overdue, yellow when nearing due date and green wherever there is sufficient time for implementation.

Certification

Section 302 requires that management certify on a quarterly basis that the internal controls over financial reporting are operating effectively. Section 404 annually requires that management comment in their annual financial reports on the effectiveness of the internal control system over financial reporting, and note the objective basis as to how this was determined. External auditors are then required to attest on the system and managements comments.

In order to do both 302 and 404 certifications and comments, management need to satisfy themselves that the system is functioning effectively, view evidence of an effective functioning system, assess the materiality of non complying controls, and review business unit management's assertions, summaries and certifications.

Provides the following functionality for certification:
Controls self assessment highlights compliant and non compliant controls. The related actions provide the evidence of management actions to rectify non complying controls,
Process certification provides the comprehensive assessment as to non compliant controls within the process, actions, related risks, compensating controls—all summarized in the summary and conclusions section of the process profile. This would be completed in to satisfy quarterly certifications.
Each business unit will use the standard forms/templates available in the governance framework which allow the business unit owner to complete the controls summary and certify that the controls over financial reporting are operating effectively and no material weaknesses exist. The business unit CEO and CFO will also be required to certify the summary and the controls. Once completed the corporate owner is notified and can the access the various business unit summaries and certifications. The corporate owner cannot complete the corporate summaries until all business units have done their summaries and certifications. Business unit owners may be required to save copies of certifications, summaries, non compliant controls actions and related heat maps, process certifications, internal audit process certifications and comments, external audit process certifications and comments, and any other reports management consider should be filed to support the certification process.
Section 302 certification requires business units to complete financial due diligence questionnaire. The financial due diligence compliance questionnaire allows the user to link the answer to parts of the internal control system as evidence to support the user in answering the financial due diligence questionnaire.
Corporate governance framework summary and certification to be completed by the corporate owner and signed by the relevant parties. A copy of the corporate certification summary and certification together with other relevant reports can be presented to the Board audit committee as part of the evidence that internal controls are operating effectively
Leaders provides meeting management functionality for the board of directors, audit committee, risk committee and any other executive or board committee that meet on a regular basis. The output from this system together with financial reports, SEC filing reports, investor presentations, press releases, can be submitted to the Leaders system for the relevant executive group to review prior to the audit committee meeting. This type of meeting functionality is also available to business units, and the relevant reports are an effective record should any third party (such as the SEC) wish to review the evidence.

Compliance questionnaire: Leaders also includes a compliance questionnaire tool which is designed to assist companies in their 302 certifications. To achieve the best 302 certification result, the compliance questionnaire should be used in conjunction with the internal control summaries and certification. The compliance questionnaire can be designed at the corporate level whereby each business unit should complete the financial due diligence questionnaire which allows the business unit CEO and CFO to certify the financial reports submitted to corporate head office. Alternatively the corporate head office can direct specific questions to the relevant individuals in each business unit and the corporate office can then present the results of the financial due diligence questionnaire to the business unit CEO and CFO for certification. The latter alternative provides greater peace of mind to the corporate CEO and CFO that the financial reports are complete and accurate and contain all relevant disclosures. The respondent to a financial due diligence questionnaire can cross reference responses to the relevant control activities and processes in the internal control system. This provides the necessary evidence to support the financial due diligence response.

Internal Audit

The System allows internal audit to certify control activities, processes, issues, components and final summaries, date the certification and pass comment in regard to the item being certified. This information is captured and retained by the system. The reporting functionality allows the internal auditor to view, print, save and archive a summary of the entire system or whatever elements are of interest to the internal auditor.

External Audit

The System allows external audit to certify control activities, processes, issues, components and final summaries, date the certification and pass comment in regard to the item being certified. This information is captured and retained by the system. The reporting functionality allows the external auditor to view, print, save and archive a summary of the entire system or whatever elements are of interest to the internal auditor.

Change Management

Whenever any changes occur which may impact the content of the internal control system it is incumbent on the corporate and business unit owners to ensure that their internal control systems are current and up to date.

The system allows the corporate or business unit owner to use the notification system to notify relevant individuals that they need to update their part of the system and ensure that each part that has changed be authorized by management.

It may be necessary to assemble a small team to get the work done, however it is critically important that the internal control systems are kept up to date and relevant otherwise it makes it impossible for the corporate CEO and CFO to do their quarterly 302 certifications and the annual 404 statement and audit attestation.

3.10 Policies, Procedures and Standard Forms.

The system allows policies and procedures of the internal control system to be captured at both the corporate and business unit level.

Policies will outline what needs to be done and the timing thereof, whereas the procedures will outline how matters will be addressed.

The system includes a comprehensive set of policies, procedures and standard forms.

3.11 Implementation

3.11.1 Controls Framework Implementation

Controls manager implementation comprises the following stages:
Project structuring.—This requires identifying the parties that will participate in the development of the system and the roles they will play. Consideration will need to be given to the appointment of advisors with the necessary skill sets to assist in developing the internal control framework and content, external auditors, internal auditors and the management charged with developing the control templates for each business unit, the business unit owners that will take responsibility for implementing the system in each business unit and the management responsible for operating the system once implemented.
Project scoping—This requires determining the type of internal control framework to be implemented, the methodology in devising the controls and the day to day functionality once implemented. Naturally the system needs to provide powerful reporting tools and consideration should be given to the level of automation required in simplifying the 302 and 404 certifications.
Identification and documentation of risks and controls. The 80-20 Leaders Online internal control module allows management to select one of a number of approaches in developing the risks and controls. The suggested approach is as follows (Alternatives are also discussed below):
   a. Accounts: Start with the financial accounts (including notes, policies and MD&A) that are lodged with the SEC. The account profile will capture such information as account owner, account value, date authorized/reviewed.
   b. Processes: The next step is to identify the processes that are linked to each account. There may well be more than one process that is linked to a particular account. At the same time a certain process may relate to a number of accounts. For example the payments process will be linked with all expenditure accounts. In addition, the process profile requires certain information to be documented. This includes a description of the process, process owner, authorization and last date the process was authorized. The system also allows for mass authorization of all accounts and related processes and process maps. The system design envisages that at least once each year the entire system (accounts and processes) is reviewed and approved by the business unit owner.
   c. Process maps: Having determined the major processes within the business, it would be advisable to map these processes in order to get a comprehensive understanding of what is involved in each process. This will make it a lot easier to identify the risks related to each process and the controls that need to be in place to manage the risks. The system allows you to map the processes and sub-processes.
   d. Process owner responsibilities: Each process requires an owner. The owner of the process is responsible for ensuring the process description, process profile and process maps are accurate and current. In addition the process owner is responsible for:
      i. identifying the risks inherent in the process,
      ii. appointing an owner of the risk,
      iii. profiling the risk,
      iv. certifying the risk profile is accurate,
      v. identifying control activities required to manage each risk,
      vi. appointing an owner of each control activity,
      vii. accurately describing the control activities,
      viii. determining the regularity of control activity self assessment eg monthly, quarterly or annually
      ix. reviewing and revising action plans related to non compliant controls
      x. certifying that the process and related controls are functioning effectively. The certification requires a summary and conclusion and details of any actions under way.
      xi. The process profile also provides certification functionality for the internal and external auditor, date certified and any comments the auditor wishes to make regarding the process in question.
   e. Process owner—Reports: The process owner can immediately identify non compliant controls from the reports section of the system.
   f. Risks: The next step is to identify the risks related to each process. If however the business decides not to identify and map the processes the risks are then related to each of the accounts, notes, policies and MD&A. The risk profile requires that certain information be documented. This includes the risk owner, type of risk, financial impact and probability rating, authorization and the last date the risk was authorized. Once again it is envisaged that risks are reviewed at least once each year to ensure the risks are still relevant and no new risks have arisen as a result of changes in business operations and processes.
   g. Risks—Quick access: The system also provides quick access to “My Risks” and both the process owner and risk owner can gain immediate access to the risks under their responsibility.
   h. Control activities: Finally control activities for each risk are identified and documented. A control activity profile requires certain information to be documented. This includes:
      i. The owner,
      ii. Control objective (selection from a fixed list of control objectives),
      iii. Management certification that the control activity is appropriate,
      iv. Description of the control activity,
      v. Financial impact in $ in the event of non compliance,
      vi. Compliance (yes/no) and in the event the control activity is not compliant,
      vii. Details of the action and due date.
      viii. The control profile also prompts the owner to determine the regularity of self assessment, ranging from monthly to an annual assessment and
      ix. The owner can also choose for the system to send an automatic reminder notification a number of days prior to self assessment due date.
      x. The control activity also provides certification functionality for the internal and external auditor, date certified and any comments the auditor wishes to make regarding the control activity in question.
   i. Control activity—Shortcuts: The system provides each control activity owner an icon “My Controls” and by clicking on “My Controls” the owner can review the profiles of their control activities. This icon also provides the process owner and the risk owner with the details of the control activities for which they are responsible.
   j. Reports: The system provides for powerful and flexible reporting based on the information captured in the profile. The business unit and corporate need to tailor the standard reports and executive dashboard to fit their requirements. The default settings for the various types of reports also need to be set. The default settings can be varied for each user.

3.11.2 Governance Framework

The governance framework consists of 3 elements. These are the components, points of focus and issues.

The system provides a standard set of documentation for the entire governance framework. Companies can tailor the standard set of documentation to their requirements. The standard documentation is based on the COSO document titled, “Internal Control—Integrated Framework”

The components also include provision for summaries and certification in a standard format. These need to be tailored to the specific requirements of the corporation.

The governance framework also provides a standard set of policies and procedures.

The standard set of policies and procedures can guide the corporation in tailoring these policies and procedures to meet their specific requirements.

3.12 Benefits

The benefits of the system include the following
Comprehensive and fully integrated Sox suite including Leaders Board and Executive meeting management (Command centre), Controls manager, Certification manager and Disclosure manager. This is all underpinned with document and records management capability.
Comprehensive repository of controls, fully documented, with detailed profiles of components, points of focus, issues, accounts, processes, process maps, risks, and control activities,
Real time system
Comprehensive summary and certification tools and process. This includes linkage between compliance questionnaires and controls and meeting management functionality for the relevant executive and board committees, Certification manager underpins the 302 financial certifications and any other compliance processes requiring regular certification,
Full system visibility. The governance and controls framework use tree navigation functionality. At any point in the controls system the system provides a diagram mapping accounts to processes, processes to risks and risks to controls. In addition the powerful reporting functionality can provide the user with a full view of all controls and their relationship to other elements of the system, Powerful Risk heat map functionality which allows the user to view whatever risks with the required report. Heat map functionality allows for the consolidation of all risks and the corporate user can view severe and high risks for the entire corporation. Heat maps of risks relating to non complying controls can also be viewed,
Powerful reporting tools providing a wide range of reports to suite all parties,
Excellent executive dashboard overview of the system and it's current status,
Ability to attach evidence in the self assessment process,
Full set of policies, procedures and standard forms.
Implementation guidelines for the technology and controls,
Standard set of documentation for the governance framework,
Controls self assessment with notification functionality to remind users to do the self assessment
Management certification of every element of the system
Internal and external audit certification
Detailed audit logs,
Tailored solution based on the COSO internal control framework,
Full document management and data base support of the system
Scaleable across large corporations with multiple business units and users,
Quick and easy implementation
Browser access
Comprehensive security settings allowing only authorized users access to the relevant parts of the system,
All modules of the Sox suite are data base applications.

While we have described herein one specific embodiment of the invention it is envisaged that other embodiments of the invention will exhibit any number of and any combination of the features of those previously described and it is to be understood that variations and modifications in this can be made without departing from the spirit and scope of the invention.

1. An integrated application software suite for corporate governance, comprising a plurality of modules, each module of said plurality of modules having a command center, a meeting manager, a subsidiary manager, a software controls manager, a certification manager, a disclosure manager and a repository manager.

2. A software suite as claimed in claim 1, wherein the command center of a particular said module hosts other modules of said plurality of modules and provides a unified and integrated security and administration framework and a single intuitive point of access for all users.

3. A software suite as claimed in claim 1, wherein the meeting manager provides secure around the clock access from anywhere in the world to critical business information, meeting management services and accelerated reporting tools.

4. A software suite as claimed in claim 1, wherein the subsidiary manager provides a company secretary's office with a system which captures essential information on all subsidiary companies including details of officers and document lodgments.

5. A software suite as claimed in claim 1, wherein the certification manager provides a structured auditable compliance questionnaire capability to optimize the capture of compliance information.

6. A software suite as claimed in claim 1, wherein the repository manager stores, secures and manages full lifecycles of electronic objects such as documents, emails and forms as well as references to physical objects such as paper documents and folders.

7. A software suite as claimed in claim 1, wherein the software controls manager is a module for managing internal controls which software controls manager provides both a framework and tool with which to document relevant processes, process maps, risks related to each process and controls to manage the risks.

8. A software suite as claimed in claim 7, wherein the software controls manager includes the following features:
means for documenting of internal controls by that:
allows companies to document templates at the corporate level for detailed implementation at the business unit level;
collaborates on the development of risks and controls and
leverages content stored by other said modules.

9. A software suite as claimed in claim 1, wherein the software controls manager includes means for providing a comprehensive repository of accounts, related processes, risks and control activities to manage risks.

10. A software suite as claimed in claim 1, wherein the software controls manager includes means for providing an objective basis for evaluating the internal control framework through a control governance framework.

11. A software suite as claimed in claim 1, wherein the software controls manager includes means for providing a real-time assessment of the risks and controls in any business unit.

12. A software suite as claimed in claim 11 wherein the software controls manager includes means for providing a certification process meeting requirements in regard to internal controls over financial reporting.

13. A software suite as claimed in claim 1, wherein the software controls manager includes means for providing management authorization of said software suite and an internal and external audit of its functionality for certifying controls and processes.

14. A software suite as claimed in claim 1, wherein the software controls manager has means for self assessment with an ability to notify each control activity owner in advance that the control activity needs to be done and self assessment has been completed.

15. A software suite as claimed in claim 1, wherein the software controls manager includes means for providing visibility at all levels of said software suite.
